(19) United States
(12) Patent Application Publication
(10) Pub. No.: US 2012/0212542 A1
(43) Pub. Date: Aug. 23, 2012

(54) INKJET HEAD CLEANING DEVICE AND INKJET RECORDING APPARATUS

(75) Inventor: Kazuhisa Kimura, Kanagawa (JP)

(73) Assignee: TOSHIBA TEC KABUSHIKI KAISHA, Tokyo (JP)

(21) Appl. No.: 13/354,482

(22) Filed: Jan. 20, 2012

(30) Foreign Application Priority Data
Feb. 18, 2011 (JP) 2011-033360
Aug. 3, 2011 (JP) 2011-169960

(51) Int. Cl. B41J 2/165

(52) U.S. Cl. 347/33

(57) ABSTRACT

A cleaning device that cleans a nozzle surface of an inkjet head in which plural nozzles for ejecting ink are opened includes: a cleaning head that includes a supply port opposed to the nozzle surface and is movable along the nozzle surface; and a supplying section configured to supply liquid for cleaning the nozzle surface to the supply port of the cleaning head, the supplying section bulging the liquid from the supply port to the nozzle surface to form, in the supply port, a liquid wipe section that can be contact with the nozzle surface.

### CROSS-REFERENCE TO RELATED APPLICATION

This application is based upon and claims the benefit of priority from the prior Japanese Patent Application No. 2011-33360, filed on Feb. 18, 2011, and No. 2011-169960, filed on Aug. 3, 2011, the entire contents of both of which are incorporated herein by reference.

### FIELD

Embodiments described herein relate generally to a cleaning device that cleans, with liquid, a nozzle surface of an inkjet head in which plural nozzles are opened and an inkjet recording apparatus mounted with the cleaning device.

### BACKGROUND

An inkjet head includes a nozzle surface in which plural nozzles for ejecting ink are opened. If the ink adheres to the nozzle surface, ink ejection performance becomes unstable and printing quality is deteriorated. Therefore, in the past, the nozzle surface is periodically cleaned using a wipe blade.

The wipe blade is formed of a flexible elastic body such as rubber. The wipe blade moves while contacting the nozzle surface to forcibly scrape off and remove the ink, dust, and the like adhering to the nozzle surface.

### DESCRIPTION OF THE DRAWINGS

FIG. 1 is a schematic side view of an inkjet recording apparatus according to a first embodiment;

FIG. 2 is a perspective view of an inkjet head used in the first embodiment;

FIG. 3 is a perspective view of a cleaning device for the inkjet head according to the first embodiment;

FIG. 4 is a front view of a state in which a cleaning head of the cleaning device is brought into contact with the inkjet head in the first embodiment;

FIG. 5 is a side view of the state;

FIG. 6 is a perspective view of the cleaning head;

FIG. 7 is a perspective view of the cleaning head;

FIG. 8 is a plan view of the cleaning head which shows a flow channel of liquid flowing out from a supply port in the first embodiment;

FIG. 9 is a perspective view of the cleaning head which shows the flow channel of the liquid flowing out from the supply port;

FIG. 10 is a sectional view of a state in which the cleaning head is moved to a standby position out of a nozzle surface of the inkjet head in the first embodiment;

FIG. 11 is an enlarged sectional view of a place of F11 shown in FIG. 10;

FIG. 12 is a sectional view of a state in which the cleaning head moves to a cleaning position opposed to the nozzle surface of the inkjet head in the first embodiment;

FIG. 13 is a sectional view of the cleaning head of a state in which the liquid for cleaning swells from the supply port in the first embodiment;

FIG. 14 is a sectional view of a state in which the liquid for cleaning is filled in a gap between the supply port of the cleaning head and the nozzle surface of the inkjet head in the first embodiment;

FIG. 15 is a sectional view for explaining a positional relation between the supply port of the cleaning head and nozzles of the inkjet head when the liquid for cleaning is filled in the gap between the supply port of the cleaning head and the nozzle surface of the inkjet head in the first embodiment;

FIG. 16 is a sectional view of a state in which the cleaning head moves to the cleaning position and the liquid for cleaning overflows the supply port in the first embodiment;

FIG. 17 is an enlarged sectional view of a place of F17 shown in FIG. 16;

FIG. 18 is a sectional view for explaining a positional relation between the supply port of the cleaning head and the nozzles of the inkjet head when the liquid for cleaning overflows the supply port in the first embodiment; and

FIG. 19 is a side view of a cleaning device according to a second embodiment.

### DETAILED DESCRIPTION

According to an embodiment, an inkjet head cleaning device that cleans a nozzle surface of an inkjet head in which a nozzle for ejecting ink is opened, the device includes a cleaning head that includes a supply port opposed to the nozzle surface and is movable along the nozzle surface. The device also includes a supplying section configured to supply liquid for cleaning the nozzle surface to the supply port of the cleaning head, the supplying section bulging the liquid from the supply port to the nozzle surface to form, in the supply port, a liquid wipe section that can be contact with the nozzle surface.

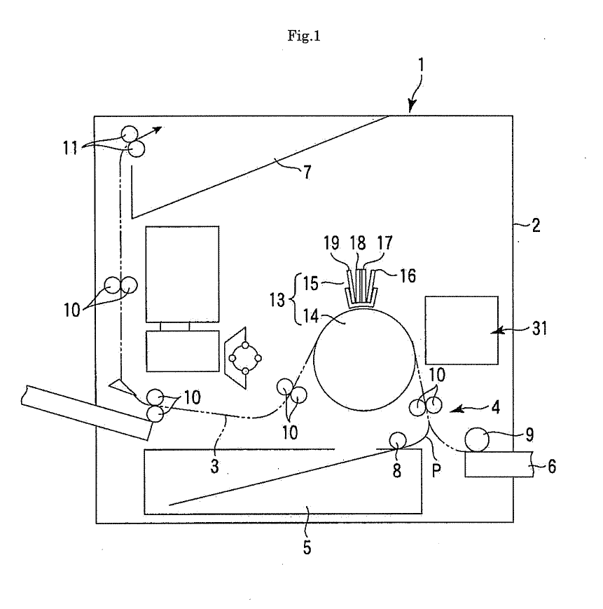

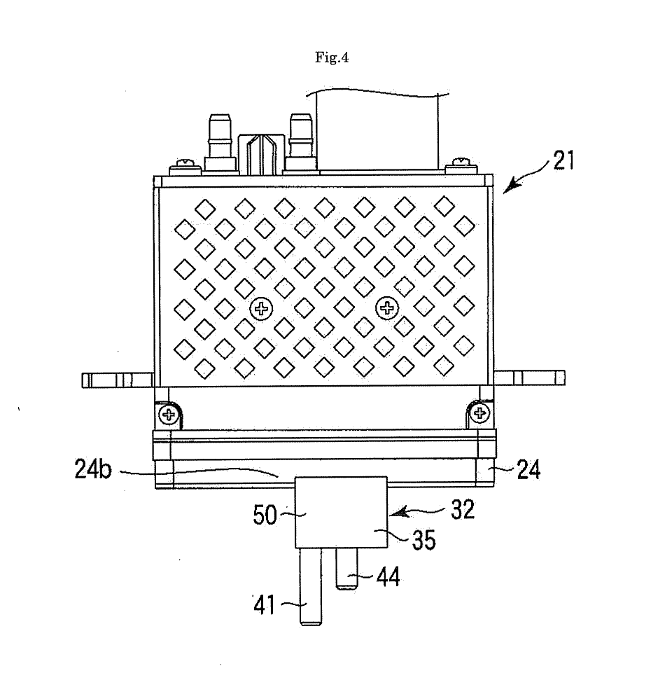

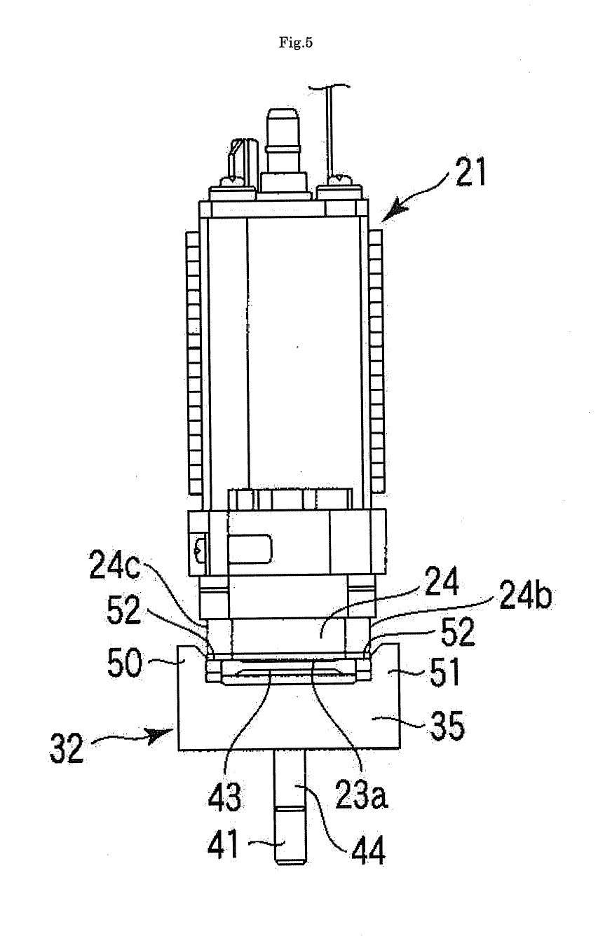

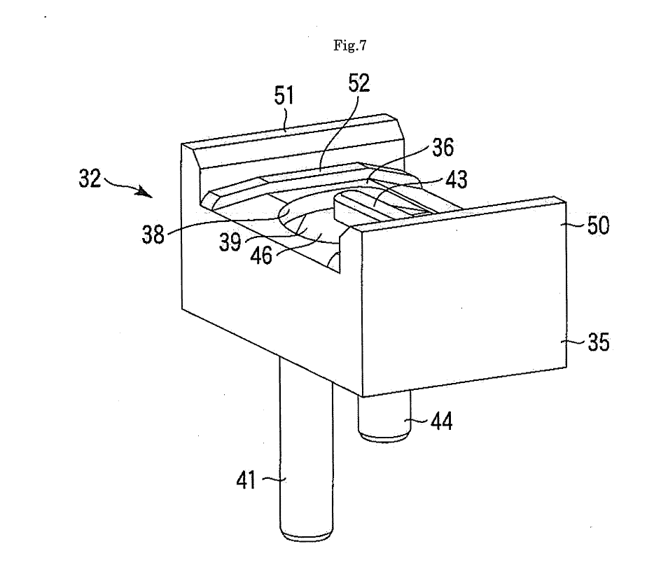

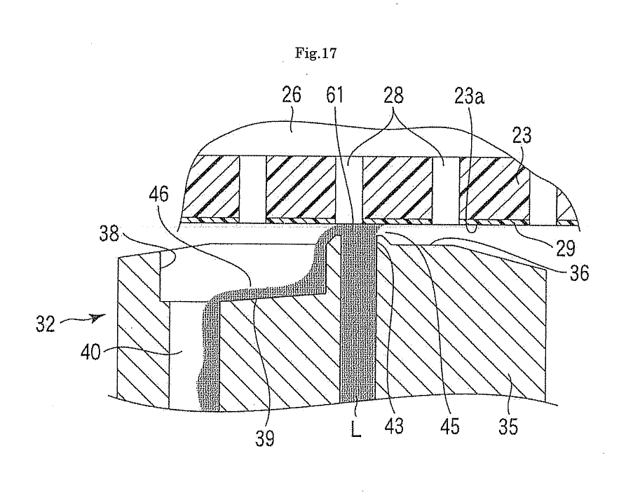

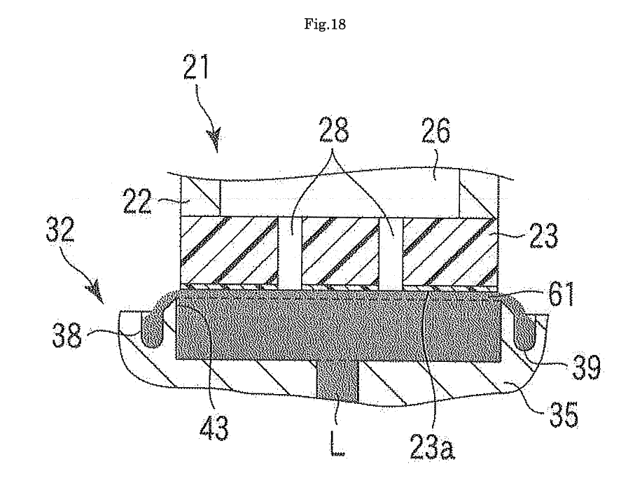

A first embodiment is explained below with reference to FIGS. 1 to 18.

In FIG. 1, an inkjet recording apparatus 1 is schematically shown. The inkjet recording apparatus 1 according to the first embodiment is an apparatus for applying color printing to a sheet P, which is an example of a recording medium. As the sheet P, for example, a plain sheet, art paper, an OHP sheet, or the like can be used.

The inkjet recording apparatus 1 includes a housing 2. The housing 2 forms an outer hull of the inkjet recording apparatus 1. A conveying path 3 and a sheet feeding mechanism 4 are provided on the inside of the housing 2. The conveying path 3 is a path for leading sheets P stored in a paper feeding tray 5 or a manual feed tray 6 to a paper discharge tray 7. The conveying path 3 extends from a bottom part of the housing 2 to an upper part of the housing 2.

The sheet feeding mechanism 4 includes a first roller 8 that delivers the sheets P stored in the paper feeding tray 5 to the conveying path 3 one by one and a second roller 9 that delivers the sheets P stored in the manual feed tray 6 to the conveying path 3 one by one. The sheet feeding mechanism 4 includes plural third rollers 10 that convey the sheet P along the conveying path 3 and plural fourth rollers 11 that feed the sheet P conveyed to the terminal end of the conveying path 3 into the paper discharge tray 7.

As shown in FIG. 1, a printing section 13 is provided along the conveying path 3. The printing section 13 includes a drum 14 around which the sheet P is wound and a printing unit 15 that applies printing based on printing data to the sheet P.

The printing unit 15 is provided above the drum 14 and opposed to the outer circumferential surface of the drum 14. The printing unit 15 includes a first nozzle module 16 that ejects cyan ink, a second nozzle module 17 that ejects yellow ink, a third nozzle module 18 that ejects magenta ink, and a fourth nozzle module 19 that ejects black ink. The first to fourth nozzle modules 16, 17, 18, and 19 are arrayed on the drum 14 from an upstream side to a downstream side in a conveying direction of the sheet P.

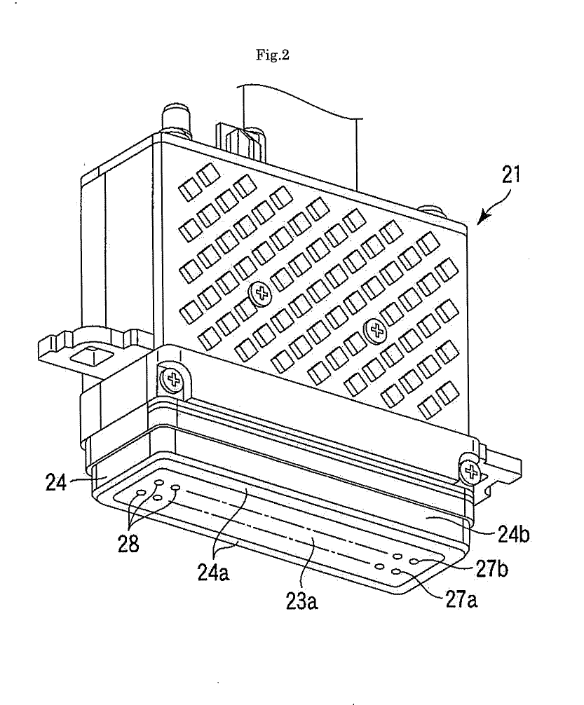

Each of the first to fourth nozzle modules 16, 17, 18, and 19 includes an inkjet head 21 shown in FIG. 2. The inkjet head 21 includes a head body 22, a nozzle plate 23, and a mask plate 24.

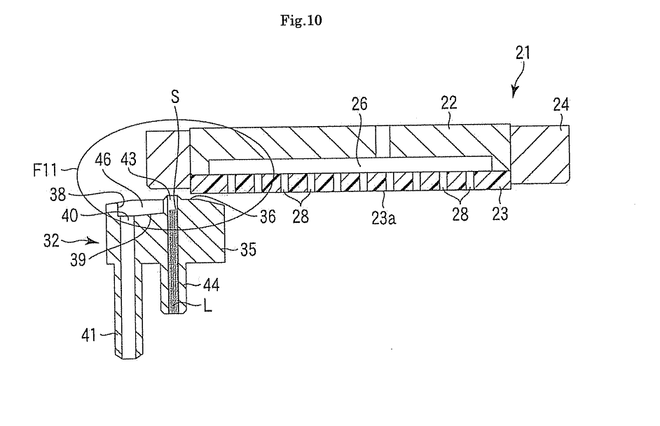

As shown in FIG. 10, the head body 22 is formed in a substantially rectangular shape and extends in the axial direction of the drum 14. The head body 22 includes an ink circulation chamber 26 to which ink is supplied. The ink circulation chamber 26 extends in the longitudinal direction of the head body 22 and is opened at the lower end of the head body 22.

The nozzle plate 23 is formed of a resin film such as polyimide. The nozzle plate 23 is fixed to the lower end of the head body 22 by means such as bonding to close the opening end of the ink circulation chamber 26.

A plurality of nozzle rows such as a pair of nozzle rows 27a and 27b are provided in the nozzle plate 23. The nozzle rows 27a and 27b extend in the longitudinal direction of the nozzle plate 23 and are arranged in parallel while being spaced apart from each other in the width direction of the nozzle plate 23.

Each of the nozzle rows 27a and 27b includes plural nozzles 28. The nozzles 28 are arranged while being spaced apart from one another in the longitudinal direction of the nozzle plate 23. The nozzles 28 are respectively opened in the lower surfaces of the ink circulation chamber 26 and the nozzle plate 23.

The lower surface of the nozzle plate 23 excluding areas where the nozzles 28 are opened is coated with, for example, a repellent liquid film 29 made of fluorine resin. The repellent liquid film 29 has an ink repelling characteristic (for example, the film can be a hydrophobic film when an aqueous ink is employed). The repellent liquid film 29 forms a nozzle surface 23a of the nozzle plate 23. The nozzles 28 are opened in the nozzle surface 23a.

The mask plate 24 surrounds the head body 22. The nozzle surface 23a of the nozzle plate 23 slightly projects downward from a guide surface 24a at the lower end of the mask plate 24. The guide surface 24a is located around the nozzle surface 23a of the nozzle plate 23 and linearly extends in the longitudinal direction of the nozzle plate 23.

With such an inkjet head 21, ink supplied to the ink circulation chamber 26 is pressed by a not-shown actuator. A part of the pressed ink is changed to plural ink droplets and ejected from the nozzles 28 to the sheet P on the drum 14.

As shown in FIG. 1, the inkjet recording apparatus 1 is mounted with a cleaning device 31 that cleans the nozzle surface of the inkjet head with liquid. The cleaning device 31 is housed on the inside of the housing 2 and adjacent to the printing unit 15. As the liquid L for cleaning, it is desirable to use, for example, ink or transparent cleaning liquid having physical properties similar to or same as those of printing ink.

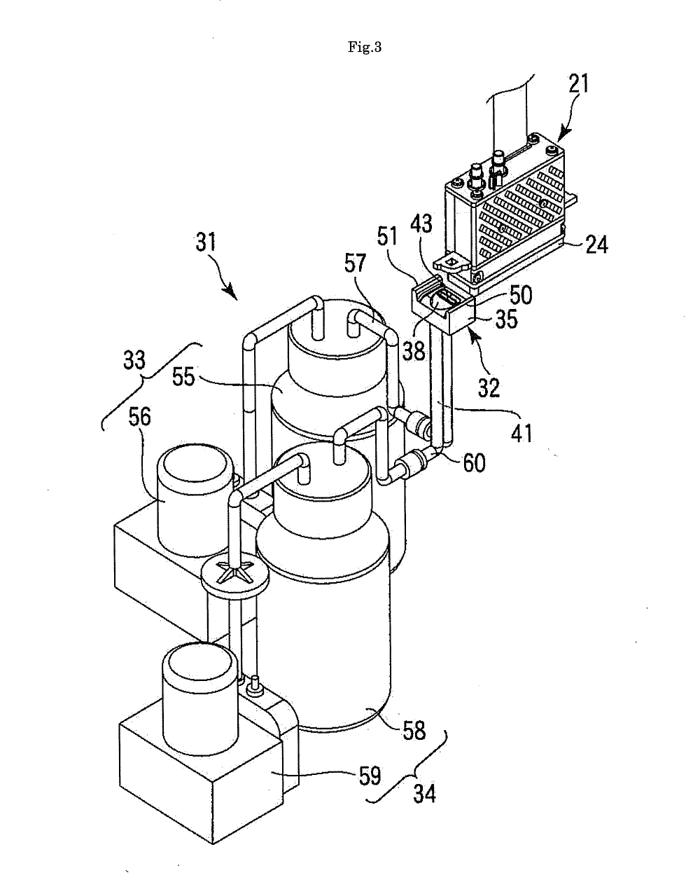

As shown in FIG. 3, the cleaning device 31 includes a cleaning head 32, a supplying section 33, and a collecting section 34.

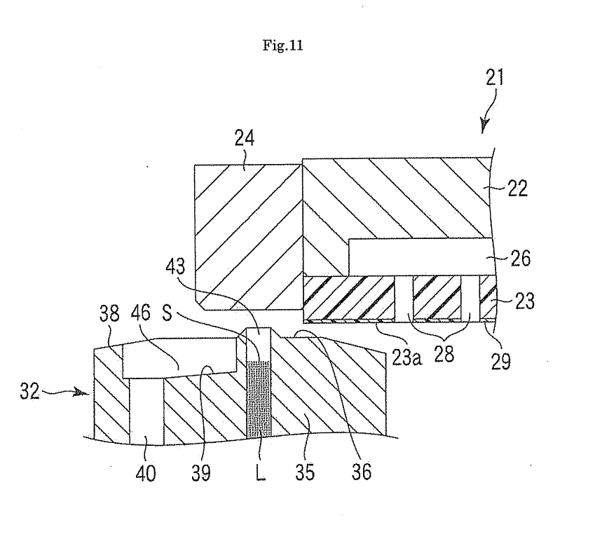

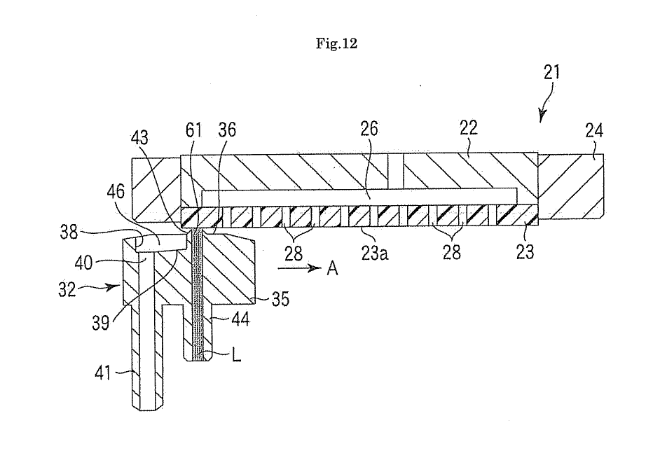

The cleaning head 32 can linearly reciprocatingly move in the longitudinal direction of the nozzle surface 23a between a standby position shown in FIGS. 10 and 11 and a cleaning position shown in FIGS. 12 to 18. Specifically, in the standby position, the cleaning head 32 withdraws to a side of the inkjet head 21 to move out of the nozzle surface 23a. In the cleaning position, the cleaning head 32 is opposed to the nozzle surface 23a of the inkjet head 21.

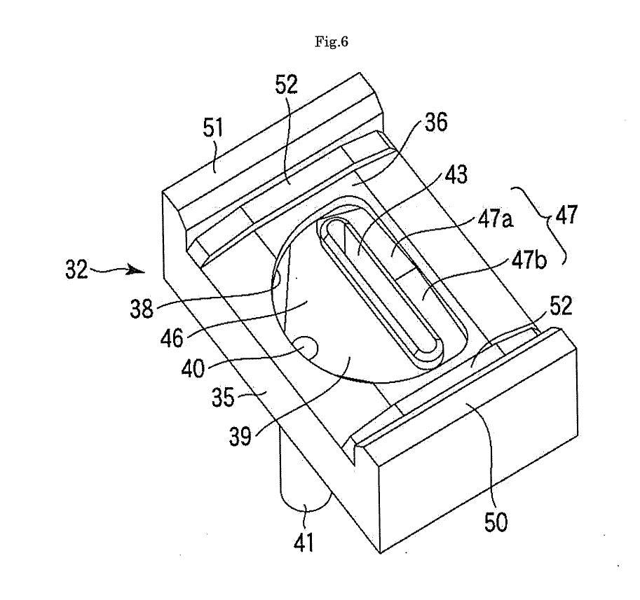

The cleaning head 32 can be linearly moved along the nozzle surface 23a by driving means such as an electric cylinder or a linear motor. Further, the cleaning head 32 can be guided in a moving direction using, for example, a guide rail extending in the longitudinal direction of the nozzle surface 23a. As shown in FIGS. 6 to 9, the cleaning head 32 includes a block-like cleaning head body 35. The cleaning head body 35 includes an upper surface 36 opposed to the nozzle surface 23a. The upper surface 36 is formed in a substantially rectangular shape having a width dimension traversing the nozzle surface 23a in the width direction. A dimension in the longitudinal direction of the nozzle surface 23a is smaller than the total length of the nozzle surface 23a.

A recess 38 is formed in the center of the upper surface 36 of the cleaning head body 35. A bottom surface 39 of the recess 38 is tilted further downward in a direction from one end to the other end in the moving direction of the cleaning head 32. A collection port 40 is formed in a position recessed most on the bottom surface 39 of the recess 38. The collection port 40 communicates with a liquid outlet 41 projected from the bottom of the cleaning head body 35.

A supply port 43 is formed in the bottom surface 39 of the recess 38. The supply port 43 has a slit-like opening shape extending in the width direction of the cleaning head body 35. The supply port 43 communicates with a liquid inlet 44 projected from the bottom of the cleaning head body 35.

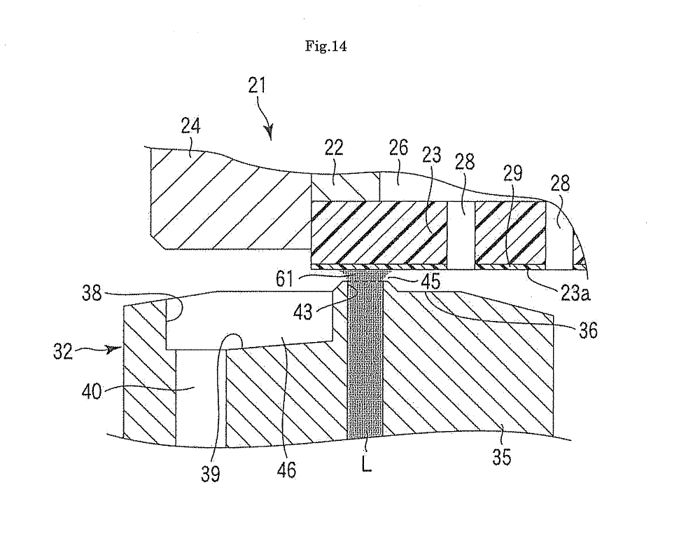

An opening end of the supply port 43 projects upward from the bottom surface 39 of the recess 38 and slightly protrudes from the upper surface 36 of the cleaning head body 35. Therefore, in a state in which the cleaning head 32 is moved to the cleaning position, a gap 45 shown in FIG. 14 is formed between the opening end of the supply port 43 and the nozzle surface 23a of the inkjet head 21.

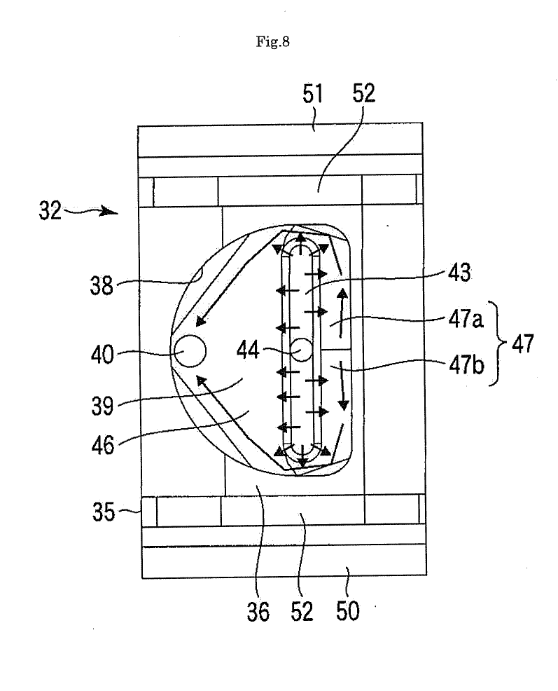

As shown in FIG. 8, the supply port 43 is provided, with respect to the collection port 40, closer to one side in the moving direction of the cleaning head 32. Therefore, the supply port 43 divides the inside of the recess 38 into a first area 46 and a second area 47. The first area 46 directly communicates with the collection port 40. The second area 47 is located on the opposite side of the collection port 40 across the supply port 43.

According to the first embodiment, the second area 47 includes two slopes 47a and 47b. The slopes 47a and 47b extend in the longitudinal direction of the supply port 43 while being bordered at an intermediate point in the width direction of the cleaning head body 35. In addition, the slopes 47a and 47b are tilted further downward as the slopes 47a and 47b recede from the intermediate point. The slopes 47a and 47b communicate with the first area 46 bypassing both ends in the longitudinal direction of the supply port 43.

As shown in FIGS. 6 to 8, the cleaning head body 35 includes first and second guide walls 50 and 51. The first and second guide walls 50 and 51 are opposed to each other across the supply port 43 and extend in the moving direction of the cleaning head 32.

The inner side surfaces of the first and second guide walls 50 and 51 slidably come into contact with side surfaces 24b and 24c of the mask plate 24 when the cleaning head 32 back and forth moves. Consequently, the mask plate 24 is held between the first guide wall 50 and the second guide wall 51. Relative positions in the width direction of the inkjet head 21 and the cleaning head 32 are set.

Sliding surfaces 52 are respectively formed at a corner defined by the upper surface 36 of the cleaning head body 35 and the first guide wall 50 and a corner defined by the upper surface 36 of the cleaning head body 35 and the second guide wall 51. The sliding surfaces 52 are an example of guide sections. When the cleaning head 32 is moved to the cleaning position, the sliding surfaces 52 come into contact with the guide surface 24a of the mask plate 24. According to this contact, the predetermined gap 45 is formed between the opening end of the supply port 43 and the nozzle surface 23a of the inkjet head 21.

As shown in FIG. 3, the supplying section 33 of the cleaning device 31 includes a supply tank 55 in which the liquid L for cleaning the nozzle surface 23a is filled and a first pump 56 that presses the liquid L in the supply tank 55. The supply tank 55 is connected to the liquid inlet 44 of the cleaning head 32 via a supply pipe 57.

The collecting section 34 of the cleaning device 31 includes a collection tank 58 in which the liquid L used for cleaning of the nozzle surface 23a is collected and a second pump 59 that sucks the liquid L used for cleaning of the nozzle surface 23a into the collection tank 58. The collection tank 58 is connected to the liquid outlet 41 of the cleaning head 32 via a collection pipe 60.

The liquid L for cleaning pressed by the first pump 56 is fed from the supply tank 55 to the supply port 43 of the cleaning head 32 via the supply pipe 57 and the liquid inlet 44. In the first embodiment, the first pump 56 is controlled to enable the liquid L fed to the supply port 43 to maintain a state in which the liquid L swells from the supply port 43.

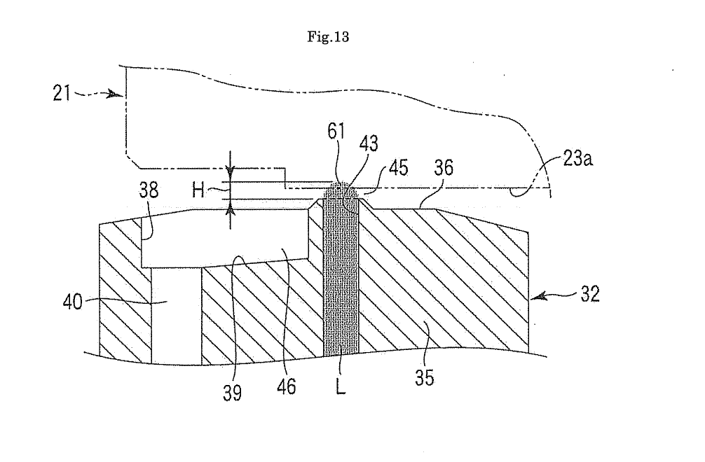

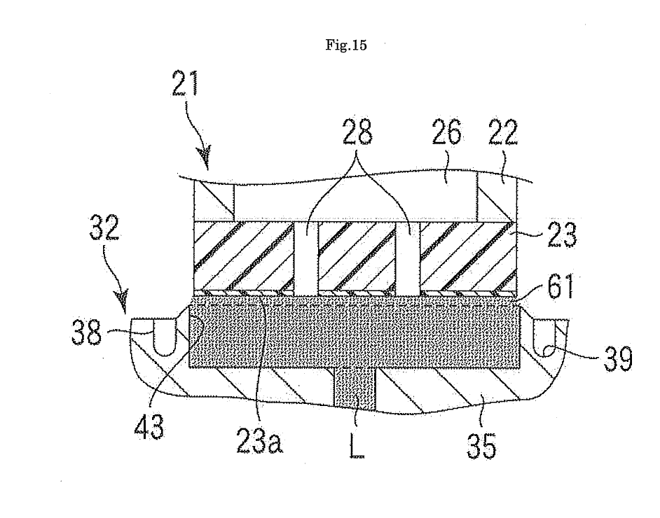

As a result, as shown in FIGS. 13 and 15, a liquid wipe section 61 formed of the liquid L is formed in the supply port 43 of the cleaning head 32. The liquid wipe section 61 is formed in a slender plate shape traversing the nozzle surface 23a in the width direction and maintains a state in which the liquid wipe section 61 swells from the supply port 43 without overflowing the supply port 43.

Projection height H of the liquid wipe section 61 from the supply port 43 is determined according to one or more of, for example, physical properties of the liquid L for cleaning, the shape of the supply port 43, the material of the cleaning head body 35, characteristics of the supply port 43 decided by water repellency and the like, and pressure applied to the liquid L. The pressure applied to the liquid L is set to a suitable value on the basis of a relation between the physical properties of the liquid L and characteristics of the supply port 43 and the size of the gap 45.

A procedure for cleaning the nozzle surface 23a of the inkjet head 21 with the liquid L is explained.

In FIGS. 10 and 11, a state before execution of cleaning of the nozzle surface 23a of the inkjet head 21 is shown. In this non-cleaning or pre-cleaning state, the cleaning head 32 retracts to the standby position where the cleaning head 32 withdraws from the nozzle surface 23a to the side of the inkjet head 21. When the cleaning head 32 is in the standby position, it is desirable to control the first pump 56 to reduce the pressure applied to the liquid L in the supply tank 55 to be lower than that during cleaning or stop the operation of the first pump 56.

As a result, the liquid L is stopped on the inner side of the supply port 43 of the cleaning head 32 without swelling from the supply port 43. In other words, as shown in FIG. 11, a liquid surface S of the liquid L is located below the opening end of the supply port 43.

Therefore, the liquid L does not overflow from the supply port 43. It is possible to prevent the periphery of the inkjet head 21 and the inside of the housing 2 from being soiled by the liquid L. At the same time, since the liquid L does not swell leading to exposure to the atmosphere from the supply port 43, it is possible to prevent the liquid L from being dried and deteriorated.

In FIGS. 12 to 18, a state in which the cleaning head 32 moves from the standby position to the cleaning position and cleans the nozzle surface 23a is shown. In the cleaning position, first, the cleaning head 32 reaches one end of the nozzle surface 23a. The sliding surfaces 52 of the cleaning head 32 slidably come into contact with the guide surface 24a of the mask plate 24 in the direction of arrow A.

According to this contact, relative positions of the inkjet head 21 and the cleaning head 32 are set. The predetermined gap 45 is formed between the supply port 43 of the cleaning head 32 and the nozzle surface 23a of the inkjet head 21.

At a point when the cleaning head 32 reaches one end of the nozzle surface 23a, the first pump 56 is controlled to set the pressure applied to the liquid L in the supply tank 55 to be higher than the pressure applied when the cleaning nozzle 32 is present in the standby position. Consequently, as shown in FIGS. 13 and 15, the liquid L swells to bulge or protrude from the supply port 43 and the swelling liquid L forms the liquid wipe section 61 on the supply port 43.

As shown in FIG. 14, the liquid wipe section 61 is densely filled in the gap 45 between the supply port 43 and the nozzle surface 23a and retained in a state in which the liquid wipe section 61 spreads along the nozzle surface 23a with the surface tension of the liquid L.

If the liquid wipe section 61 comes into contact with the nozzle surface 23a, the cleaning head 32 is moved from one end of the nozzle surface 23a in a direction of an arrow A shown in FIG. 12 along the longitudinal direction of the nozzle surface 23a. According to the movement, the liquid wipe section 61 wipes the nozzle surface 23a and removes foreign matters such as residual ink and dust adhering to the nozzle surface 23a and solidified.

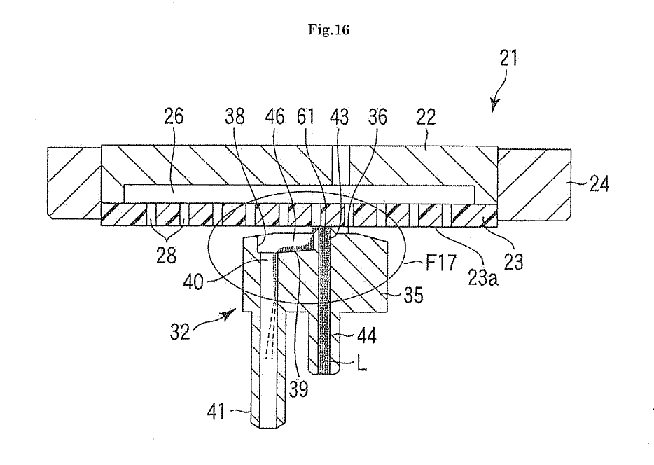

When the cleaning head 32 moves, as shown in FIGS. 16 to 18, the liquid L forming the liquid wipe section 61 flows out from the supply port 43 according to contact with the nozzle surface 23a and washes away the foreign matters removed from the nozzle surface 23a.

In this case, since the pressurized liquid L is continuously supplied to the supply port 43, the supply port 43 is filled with the liquid L. In other words, even in a process in which the cleaning head 32 moves, the liquid wipe section 61 maintains a swollen shape protruding from the supply port 43.

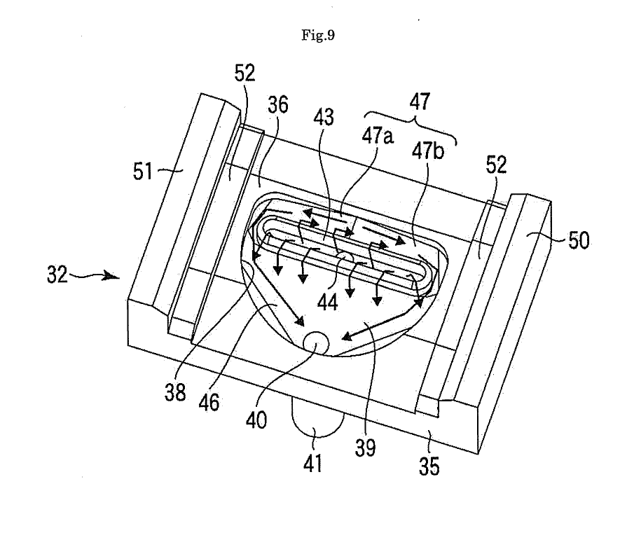

In FIGS. 8 and 9, a flowing direction of the liquid L flowing out from the supply port 43 is shown. As indicated by arrows in FIGS. 8 and 9, the liquid L flows out from the opening end of the supply port 43 into the recess 38 according to the movement of the cleaning head 32.

The liquid L flowing into the first area 46 of the recess 38 from the supply port 43 is directly led to the collection port 40. The liquid L flowing into the second area 47 of the recess 38 from the supply port 43 flows in opposite directions along the slopes 47a and 47b. Further, the liquid L flows into the first area 46 bypassing both the ends in the longitudinal direction of the supply port 43 and is led to the collection port 40 from the first area 46.

The liquid L containing the foreign matters led to the collection port 40 is collected in the collection tank 58 from the liquid outlet 41 via the collection pipe 60 according to a suction operation of the second pump 59.

After traversing from one end to the other end of the nozzle surface 23a, the cleaning head 32 moves to one end of the nozzle surface 23a again while cleaning the nozzle surface 23a with the liquid wipe section 61. According to repetition of such movement of the cleaning head 32, a series of cleaning actions for the nozzle surface 23a ends.

When the cleaning of the nozzle surface 23a ends, the cleaning head 32 moves from the cleaning position to the standby position. At the same time, when the cleaning head 32 moves to the standby position, the liquid surface S of the liquid L is located below the opening end of the supply port 43. Therefore, the liquid wipe section 61 is not formed in the supply port 43.

According to the first embodiment explained above, the liquid wipe section 61 that cleans the nozzle surface 23a of the inkjet head 21 is formed of the liquid L such as ink or cleaning liquid having physical properties same as those of ink for printing. The liquid L flows out from the supply port 43 according to the movement of the cleaning head 32 and washes away the foreign matters removed from the nozzle surface 23a.

Therefore, the foreign matters do not remain in the liquid wipe section 61. Fresh liquid L is always in contact with the nozzle surface 23a. Therefore, compared with wiping of the nozzle surface 23a by the wipe blade in the past, it is possible to efficiently and surely clean the nozzle surface 23a.

Further, since the liquid L is in contact with the nozzle surface 23a, the repellent liquid film 29 forming the nozzle surface 23a is not damaged.

As a result, there is an advantage that it is possible to satisfactorily maintain ink ejection performance of the inkjet head 21 for a long period and printing quality stabilizes.

In the first embodiment, the first pump 56 is controlled to prevent the liquid L forming the liquid wipe section 61 from overflowing the supply port 43. However, the first pump 56 can be controlled to allow the liquid L to overflow the supply port 43.

Specifically, the first pump 56 is controlled to set the pressure of the liquid L supplied to the supply port 43 in cleaning the nozzle surface 23a to be higher than the pressure of the liquid L necessary for forming the liquid wipe section 61. Consequently, it is possible to cause the liquid L to overflow the supply port 43 while forming the liquid wipe section 61 in the supply port 43.

With this configuration, fresh liquid L overflowing the supply port 43 is always in contact with the nozzle surface 23a. It is possible to quickly wash away the foreign matters removed from the nozzle surface 23a using the overflowing liquid L. Therefore, it is possible to further improve the cleaning effect of the nozzle surface 23a.

In the first embodiment, the liquid in the supply tank is pressed by the first pump to lead the liquid to the supply port of the cleaning head. However, the liquid may be led to the supply port making use of a water head difference.

Further, when the cleaning head moves to the standby position, the supply port of the cleaning head can be closed by a cap to actively prevent drying and deterioration of the liquid for cleaning.

A second embodiment is now explained.

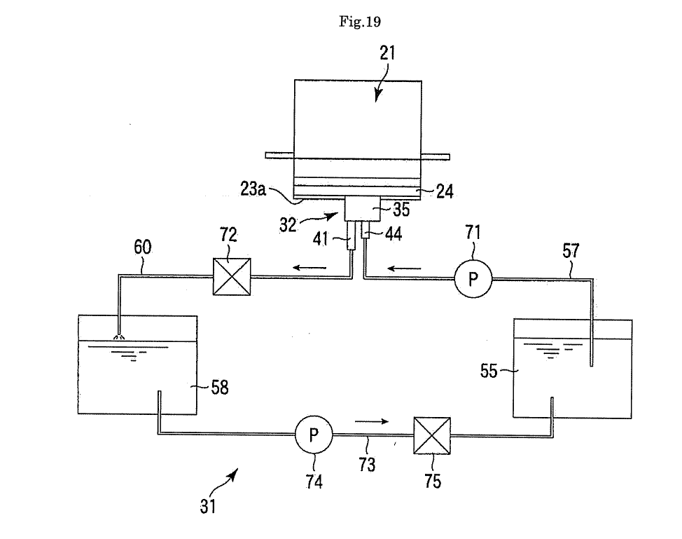

The second embodiment is depicted in FIG. 19.

The second embodiment is different from the first embodiment in that liquid for cleaning a nozzle surface is circulated and reused. Otherwise, the configuration of a cleaning device is the same as that in the first embodiment. Therefore, in the second embodiment, components same as those in the first embodiment are denoted by the same reference numerals and signs and explanation of the components is omitted.

As shown in FIG. 19, a first supply pump 71 is provided in the supply pipe 57 that connects the liquid inlet 44 of the cleaning head 32 and the supply tank 55. The first supply pump 71 supplies liquid in the supply tank 55 to the cleaning head 32.

A first filter 72 is provided in the collection pipe 60 that connects the liquid outlet 41 of the cleaning head 32 and the collection tank 58. The first filter 72 removes foreign matters contained in the liquid after cleaning of the nozzle surface 23a to prevent the foreign matters from flowing into the collection tank 58.

Further, in the second embodiment, the supply tank 55 and the collection tank 58 are connected via a recirculation pipe 73. A second supply pump 74 and a second filter 75 are provided along the recirculation pipe 73. The second supply pump 74 feeds the liquid returned from the cleaning head 32 to the collection tank 58 into the supply tank 55. The second filter 75 filters the liquid fed from the collection tank 58 to the supply tank 55 to clean the liquid.

According to the second embodiment, it is possible to circulate and reuse the liquid used for cleaning the nozzle surface 23a of the inkjet head 21. Therefore, for example, even if the liquid is always caused to overflow the supply port 43 of the cleaning head 32 to clean the nozzle surface 23a, the liquid is not wasted due to recycling mechanisms. This is convenient for improving the cleaning effect of the nozzle surface 23a.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet head cleaning device that cleans a nozzle surface of an inkjet head in which a nozzle for ejecting ink is opened, the inkjet head cleaning device comprising:
a cleaning head that includes a supply port opposed to the nozzle surface and is movable along the nozzle surface; and
a supplying section configured to supply liquid for cleaning the nozzle surface to the supply port of the cleaning head, the supplying section bulging the liquid from the supply port to the nozzle surface to form, in the supply port, a liquid wipe section that contacts the nozzle surface.

2. The device according to claim 1, wherein the liquid wipe section is filled in a gap between the nozzle surface and the supply port.

3. The device according to claim 2, wherein the cleaning head includes a guide section that slidably comes into contact with a periphery of the nozzle surface to define the gap.

4. The device according to claim 2, wherein the cleaning head is movable between a cleaning position opposed to the nozzle surface and a standby position out of the nozzle surface and, in the standby position, a liquid surface of the liquid is located below an opening end of the supply port.

5. The device according to claim 4, wherein the supplying section is configured to press the liquid and supply the liquid to the supply port when the cleaning head is moved to the cleaning position and reduce pressure applied to the liquid when the cleaning head is moved to the standby position.

6. The device according to claim 5, further comprising a collecting section that collects the liquid overflowing the supply port.

7. The device according to claim 6, wherein the cleaning head includes a recess into which the liquid overflowing the supply port flows, and the recess is caused to communicate with the collecting section.

8. An inkjet head cleaning device that cleans a nozzle surface of an inkjet head in which plural nozzles for ejecting ink are opened, the inkjet head cleaning device comprising:
a cleaning head that includes a supply port opposed to the nozzle surface and is movable along the nozzle surface; and
a supplying section configured to supply liquid for cleaning the nozzle surface to the supply port of the cleaning head, the supplying section causing the liquid to flow out from the supply port to form, in the supply port, a liquid wipe section that contacts the nozzle surface.

9. The device according to claim 8, wherein the liquid wipe section is formed of the liquid that swells from an opening end of the supply port to the nozzle surface.

10. The device according to claim 9, wherein the cleaning head is movable between a cleaning position opposed to the nozzle surface and a standby position out of the nozzle surface and, in the standby position, a liquid surface of the liquid is located below the opening end of the supply port.

11. The device according to claim 10, further comprising a collecting section that collects the liquid flowing out from the supply port.

12. The device according to claim 11, wherein the cleaning head includes a recess into which the liquid overflowing the supply port flows, and the recess is caused to communicate with the collecting section.

13. The device according to claim 1, wherein the liquid is ink or cleaning liquid having physical properties same as those of the ink ejected from the nozzles.

14. The apparatus according to claim 1, wherein the liquid wipe section contacts the nozzle surface when the cleaning device is in a cleaning position.

15. The apparatus according to claim 1, wherein the liquid wipe section does not contact the nozzle surface when the cleaning device is in a standby position.

16. An inkjet recording apparatus comprising:
a housing;
a conveying path that is provided in the housing and conveys a recording medium;
an inkjet head that includes a nozzle surface in which plural nozzles are opened and ejects ink from the nozzles to the recording medium; and
a cleaning device that cleans the nozzle surface of the inkjet head, the cleaning device including: a cleaning head that includes a supply port opposed to the nozzle surface and is movable along the nozzle surface; and a supplying section configured to supply liquid for cleaning the nozzle surface to the supply port of the cleaning head, the supplying section forming, in the supply port, a liquid wipe section that contacts the nozzle surface.

17. The apparatus according to claim 16, wherein the liquid wipe section is formed of the liquid that swells from the supply port to the nozzle surface.

18. The apparatus according to claim 16, wherein the liquid wipe section is formed of the liquid flowing out from the supply port.

19. The apparatus according to claim 16, wherein the liquid wipe section contacts the nozzle surface when the cleaning device is in a cleaning position.

20. The apparatus according to claim 16, wherein the liquid wipe section does not contact the nozzle surface when the cleaning device is in a standby position.
